(19) United States
(12) Patent Application Publication
(10) Pub. No.: US 2003/0116946 A1
(43) Pub. Date: Jun. 26, 2003

(54) Side impact protection device for motor vehicles

(75) Inventor: Peter Roos, Sulzbach (DE)

Correspondence Address: FOLEY AND LARDNER, SUITE 500, 3000 K STREET NW, WASHINGTON, DC, 20007, US

(73) Assignee: TAKATA-PETRI AG

(21) Appl. No.: 10/286,747

(22) Filed: Nov. 1, 2002

Related U.S. Application Data
(63) Continuation of application No. PCT/DE01/01671, filed on Apr. 30, 2001.

(30) Foreign Application Priority Data
May 3, 2000 (DE) 100 22 078.9

(51) Int. Cl. B60R 21/22

(52) U.S. Cl. 280/730.2

(57) ABSTRACT

A side impact protection device for motor vehicles having an unfoldable protective element, in particular for the head/thorax area of a motor vehicle occupant. The device includes an elongate traction device which is designed as a separate part, extends in the region of the lower edge of the unfolded protective element and is at least partially connected to the lower edge of the unfolded protective element and extends between at least two points which are spaced apart in the longitudinal direction of the vehicle and are fixed on the bodywork. The protective device also includes a tensioning device which is fixed to the vehicle and is intended for tensioning the traction device between the at least two points fixed on the bodywork when or shortly after the protective element is unfolded. The tensioning device exerts a tensile force on the traction device in the longitudinal direction of the vehicle.

### CROSS-REFERENCE TO RELATED APPLICATIONS

This is a continuation of International Application PCT/DE01/01671, which has an international filing date of Apr. 30, 2001; this International Application was not published in English, but was published in German as WO 01/83269.

### BACKGROUND

The invention relates to a side impact protection device for motor vehicles.

Airbag systems are known which, in the case of a side impact, unfold between the passenger and side structure of the motor vehicle and thereby provide side protection. The intention, in particular, is to prevent the motor vehicle occupant's head from impacting against a side window or a motor vehicle pillar or the head or other limbs from hanging laterally out of the motor vehicle if the side collision involves the motor vehicle rolling over.

However, the known airbag systems guarantee a protective effect in the case of a side impact only so long as the airbag is tensioned at high gas pressure. If the airbag is relaxed, for example due to gas escaping from the airbag or due to the gas in the airbag cooling, the airbag can no longer exert its protective function in an optimum manner. In particular, there is a risk, when an airbag is relaxed, of the head or extremities hanging out laterally, for example if the motor vehicle rolls over following the side impact or in the case of follow-on accidents.

WO-A1-99/41110 discloses a restraining device for motor vehicle occupants, in which an airbag, as it is being inflated, is pulled into a certain position and held in this position by means of a tensioning device which is connected to the motor vehicle and acts on the airbag. The known restraining device exerts a tensile force on the ends of the airbag, so that bracing of the airbag to a certain extent is provided.

### SUMMARY OF THE INVENTION

The present invention is based in part on the object of providing a side impact protection device for motor vehicles, which device ensures long-lasting and effective tensioning of a protective element and thereby provides improved protection of a motor vehicle occupant in a side impact.

According to an embodiment of the present invention a side impact device protection device is provided that includes an elongate traction device which is at least partially connected to the lower region of the protective element and which is tensioned between at least two points of the motor vehicle by at least one tensioning device when or shortly after the protective element is unfolded. In this case, the tensioning device brings about, in interaction with the traction device, an active tensioning essentially of the entire lower region of the protective element, and not merely a pointwise pulling at the corner regions of the protection device. By this means, a very highly effective, long-lasting protection against individual limbs or occupants hanging out laterally is provided, and an impact against the side windows or against the side structure of the motor vehicle is reliably prevented even in the case of follow-on accidents.

In a preferred refinement of the invention, the traction device runs essentially along the lower edge of the unfolded protective element. This makes it possible to actively tension the protective element over the entire length of the protective element. An effective and reliable bracing of the protective element or side protection is produced. The upper edge of the protective element is fastened to the motor vehicle, in particular along the roof frame between the A-pillar and B-pillar or C-pillar.

The connection of the traction device to the protective element can take place via a threaded-in connection of the traction device to the protective element, for example via loops, tucks or the like. As an alternative, provision may be made to connect the traction device directly to the material of the protective element, for example to sew the traction device into the protective element or to bond it to the latter.

The traction device is preferably designed as a continuous connecting cable or connecting band. However, it likewise lies within the scope of the invention to compose the tractive cable from subsections which are connected to one another via protective element material or else additional tensioning devices.

In a preferred refinement, the protective element is designed as a continuous part which extends as a single part, for example from the A-pillar as far as the B-pillar or else C-pillar and D-pillar. Alternatively, the protective element is formed from a plurality of subsegments which are arranged one behind another in the longitudinal direction of the motor vehicle and are connected to one another. In order to ensure the active bracing according to the invention of the protective element even in such a case, the lower, respectively adjacent subsegments of the protective element are connected to one another by the traction device or by subsections of the traction device, so that in spite of the division into a plurality of subsegments, the system can be braced actively as a whole.

The bracing of the protective element takes place via a tensioning of the traction device connected to the protective element. A number of variants are possible for tensioning the traction device. In a first variant, two tensioning devices are provided for tensioning the traction device, said tensioning devices each holding one end of the traction device and being fastened opposite each other in the motor vehicle, fixed on the bodywork. The protective element lies between the two tensioning devices. In this variant, an active tensioning of the tractive cable takes place in both longitudinal directions.

In a second variant, only one tensioning device is provided for tensioning the traction device, said device being arranged in the region of the one lateral end of the unfolded protective element and holding the one end of the traction device. The other end of the traction device is fastened in a positionally fixed manner to the bodywork at the opposite end of the airbag.

In a third variant, the traction device is fixed on the bodywork at both of its ends. The tensioning device, which is used for the active tensioning of the traction device, is arranged between the two ends where it interrupts the traction device and is connected to the two ends formed by the interruption. When activated, the tensioning device exerts an active tension on at least one end of the interrupted traction device, so that the traction device is tensioned as a whole. It likewise lies within the scope of the invention for the tensioning device to exert a tensile force on both ends of the interrupted traction device.

In the case of a fourth variant of the tension of the traction device, the traction device is fixed on the bodywork at both of its ends, as in the case of the abovementioned, third variant. The fourth variant involves the case in which the protective element extends over a number of motor vehicle pillars, for example from the A-pillar as far as the D-pillar. A plurality of tensioning devices are then provided, said devices being fastened in each case to a motor vehicle pillar, and in each case interrupting the traction device and, when actuated, exerting a tensile force on at least one end of the traction device, so that the traction device is in turn tensioned as a whole.

It is emphasized that the first and second variants, in which the tensioning device is arranged at the end of the traction device, can likewise be used for protective elements which extend over a number of motor vehicle pillars.

A tensioning device is preferably in each case assigned a restraining device for blocking a return movement of the traction device. These devices are, for example, clamps preventing a return movement of the traction device. The use of restraining devices ensures that the tension built up in the system is maintained over a long time (for example in the case of a rollover).

The triggering of the tensioning device(s) can take place both by means of a central triggering device and also in a decentralized manner via sensors arranged on the respective tensioning devices. A central triggering of the tensioning device has the advantage that triggering of the tensioning devices in a manner matched to the events of the accident can take place. For example, provision may be made, when an airbag is used as the protective element, for the tensioning devices to be automatically triggered when the airbag is triggered. Provision may also be made not to trigger the tensioning device until a short time after the airbag, since an active tensioning of the airbag does not have to be available immediately, but rather only after relaxation of the airbag.

In an advantageous development of the invention, unfolding aids are provided on the motor vehicle structure or on soft trim elements connected thereto, said aids ensuring a satisfactory and rapid unfolding of the protective element. For this purpose, for example, slide-off ramps are provided on the bodywork or as part of the soft trim of the pillars or as part of the roof lining material.

In a preferred refinement of the invention, an airbag of an airbag module serves as the protective element of the side impact protection device. The airbag module is preferably accommodated in the region of the roof frame or upper doorframe of the motor vehicle. The traction device, which is tightened, after triggering of the airbag, by means of the at least one tensioning device for bracing the airbag, is integrated in the airbag module in the region of its connection to the airbag. The ends of the traction device extend from the airbag module to the respective fastening points of the traction device on the motor vehicle structure or on a tensioning device provided there.

When the protective element is designed as an airbag, provision is preferably made to design the airbag in such a manner that it has chambers which run essentially horizontally and are arranged one above another. The formation of horizontally running chambers takes place by connecting the front and rear layers of the airbag along connecting lines running essentially horizontally. Instead of a continuous connection, a pointwise connection of the front and rear airbag layers may also take place.

The present invention provides the possibility for the first time of forming the chambers of airbags horizontally. In the case of conventional side protection systems, as are described, for example in WO 96/26087, the use of chambers running horizontally is not possible, since a vertical design of chambers is required in order to tension the system during filling of the airbag. Since the present invention enables the airbag to be tensioned by the traction device in conjunction with the at least one tensioning device irrespective of the alignment of individual airbag chambers, a restriction to vertically aligned chambers is rendered superfluous.

In an advantageous development of the invention, the airbag comprises a plurality of subsegments which extend, for example, between A- and B-pillars, B- and C-pillars and C- and D-pillars. In their lower region, the individual subsegments are connected via the traction device or subsections of the traction device in order to make active tensioning of all of the subsegments possible when the protection device is triggered. The subsegments of the airbag can advantageously in each case be filled separately by a dedicated gas generator. This enables as many individual protection regions as desired to be made available in a plurality of seat rows following one behind another.

In a further preferred refinement of the invention, the protective element is designed not as an airbag, but as a single- or multi-layered sail. The sail preferably consists of a hard-wearing, conditionally expandable material. The sail material preferably exhibits a type of plastic behavior, i.e. it is conditionally expandable and deformable in order to gently intercept the vehicle occupants.

By using a sail, a complex inflation process, as is required when airbags are used, is omitted. In connection with this, the necessity for gas generators and conducting systems for introducing the gas into the airbags is likewise inapplicable. The use of an airtight, siliconized sail material, which is used in the case of gas impermeable airbags, can also be dispensed with. A simplified, more cost effective protection device is therefore provided which, nevertheless, provides a reliable and long-lasting side protection of a motor vehicle occupant and is particularly appropriate for use in long motor vehicles, such as vans, buses or aircraft.

When a sail is used as the protective element, provision is preferably made for the tensioning device(s) to also bring about, in addition to the active bracing of the sail, its unfolding in the event of a crash. For this purpose, if appropriate, additional traction device or tightening lines are provided, which means or lines are connected to the sail and, in interaction with a tensioning device, bring about an unfolding of the sail in the event of a crash.

It is to be understood that both the foregoing general description and the following detailed description are exemplary and explanatory only and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 shows, schematically, a first exemplary embodiment of a side impact protection device in the activated state, in which the protective element is tensioned between two tensioning devices.

FIG. 2 shows a protection device according to FIG. 1, the protective element comprising subsegments connected to one another.

FIG. 3 shows a further exemplary embodiment of a protection device, the protective element being braced by means of a tensioning device arranged on the A-pillar.

FIG. 4 shows a further exemplary embodiment of a protection device, in which the protective element is braced by a tensioning device arranged on the B-pillar.

FIG. 5 shows a protection device corresponding to FIG. 1, the tensioning devices being arranged on the A-pillar and C-pillar.

FIG. 6 shows a further exemplary embodiment of a protection device, the tensioning devices being arranged on the motor vehicle pillars.

FIG. 7 shows, schematically, the fastening of a traction device to the protective element by means of loops.

FIG. 8 shows, schematically, the fastening of a traction device to the protective element by means of a tuck.

FIG. 9 shows, schematically, the fastening of a traction device to the protective element by complete connection to the protective element material.

FIG. 10 shows an exemplary embodiment of a protection device according to the invention, in which an airbag which comprises a plurality of subsegments and has chambers running horizontally is braced via a continuous traction device and tensioning devices.

### DETAILED DESCRIPTION

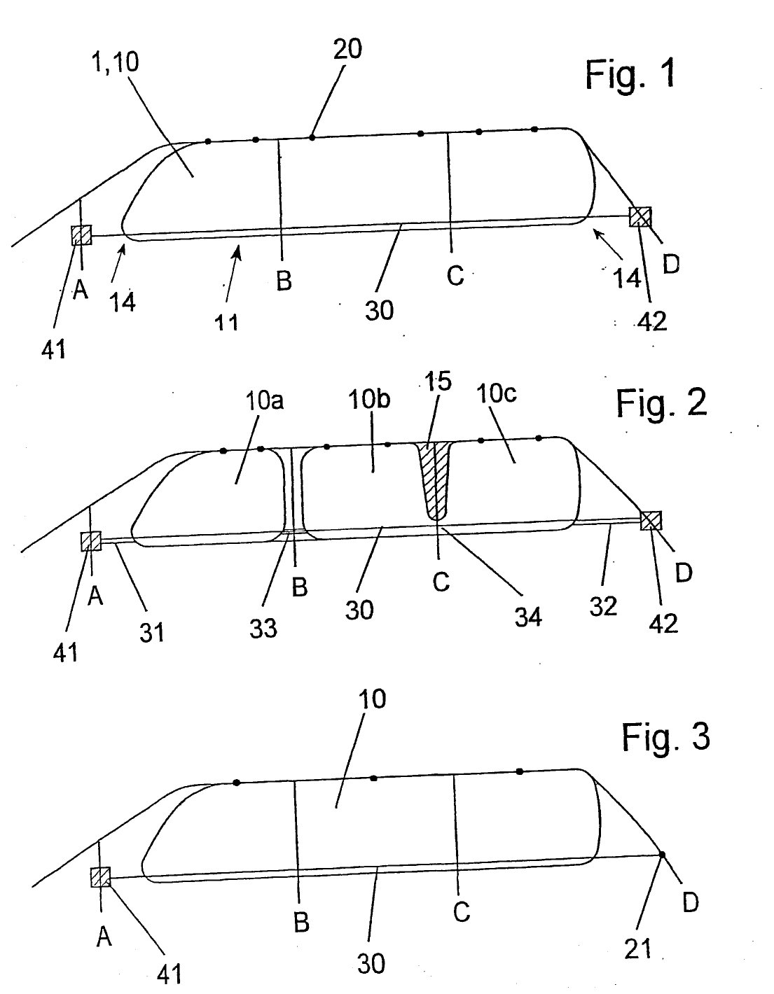

FIG. 1 shows, schematically, a side impact protection device in the activated state, in which a protective element 1 extends between the A-pillar and the D-pillar of a motor vehicle. The protective element 1 is an airbag or a single- or multi-layered sail which is fastened to the roof frame of the side structure of the motor vehicle via connecting points 20. As an alternative to a pointwise fastening via connecting points 20, a continuous fastening to the roof frame may also be provided. In the non activated state, the protective element is folded up in a housing on the roof frame.

Instead of the arrangement in a housing, provision may also be made to provide the protective element merely with a papyraceous packaging or covering. For example, the protective element is situated in a papyraceous loop which is clasped by means of clips and is partially fastened to the roof frame.

In the following description of FIGS. 1 to 8 it is assumed that the protective element 1 is a single- or multi-layered sail 10. In the same manner and with the same refinements, however, it could also be an airbag of an airbag module. The following description is therefore to be understood to the effect that an airbag may also be used instead of a sail.

According to FIG. 1, the sail 10 is designed as a single part. A traction device 30 runs along its lower edge 11, said means being connected to the motor vehicle bodywork or to elements connected thereto, such as soft trim elements, via tensioning devices (retractors) 41, 42. In the exemplary embodiment of FIG. 1, the one tensioning device 41 is fastened to the A-pillar and the other tensioning device 42 is fastened to the D-pillar, so that the tensioning means 30 extends between the A- and D-pillars.

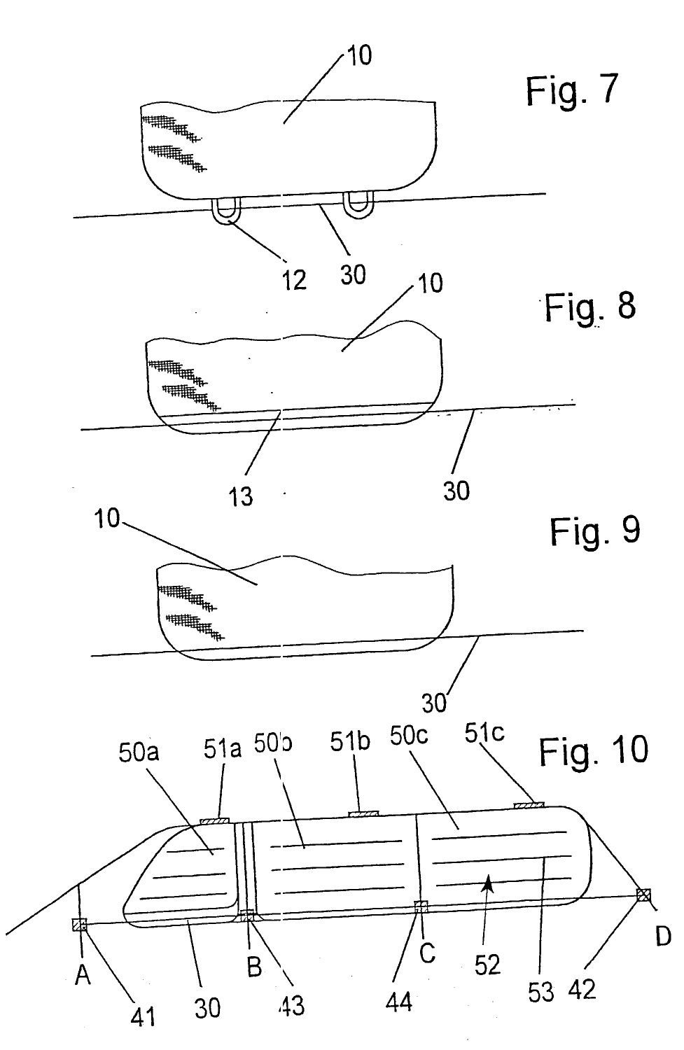

The traction device 30 is designed as a cable or as a band. It can be connected to the sail 10 in various ways. Examples in this regard are specified in FIGS. 7 to 9. In FIG. 7, a connection of the traction device 30 to the sail 10 takes place via loops 12 which are arranged on the lower edge of the sail 10 and through which the traction device 30 is threaded. In FIG. 8, a tuck or seam 13 (illustrated schematically) which forms a type of loop for the traction device 30 is provided for connecting the traction device to the sail 10. Other threaded-in systems are likewise conceivable.

According to FIG. 9, the traction device 30 is connected directly to the sail material, for example is woven into the latter or is bonded thereto.

The tensioning devices 41, 42 (illustrated schematically) (cf. FIG. 1) have an igniter or activator, after the activation of which the tensioning devices 41, 42 exert a tensile force on the traction device 30 and thereby tension the latter. In order to tension the traction device 30, the tensioning device 41, 42 has, for example, a piston which is connected to the traction device 30, is driven by gas pressure, is moved by means of a high pressure gas during a motor vehicle collision and, in the process, tensions the traction device 30. A tensioning device of this type is disclosed, for example, in DE-C2-44 20 156, to which reference is made in this respect. However, other embodiments of a tensioning device may also be used. For example, the tensioning device can operate with stressed spring elements or band-tightening means. The only essential feature is that an active tension is exerted on the traction device 30 after the tensioning device is triggered. The activation of the igniter or activator of the tensioning device 41, 42 takes place via one or more sensors, such as are also used in airbags for detecting a collision.

The tensioning device 41, 42 is preferably assigned a restraining device (return movement block) which blocks a return movement of the traction device 30. The restraining device may, for example, be formed by a clamping element or a restraining toothing. A suitable restraining device is described, for example, in DE-A1-197 07 347.

In the case of a motor vehicle collision, an active tensioning of the sail 10 takes place by means of prompt triggering of the tensioning devices 41, 42 in a manner adapted to the events of the accident. By tensioning the traction device 30, which is connected to the sail 10, between the tensioning devices 41, 42, which are fixed on the vehicle, the sail 10 is actively tensioned over its entire lower region 11 and it is thereby ensured that there is a long-lasting protection for the motor vehicle occupants against the head or other limbs hanging out.

When the tensioning devices 41, 42 are activated, the sail is pulled out of the roof frame and tensioned. In addition to an active tensioning of the sail 10, the tensioning devices 41, 42 also serve for unfolding it in the event of a collision. Thus, when the traction device 30 is tensioned, the lateral edges 14 of the sail are pulled out downward and therefore out of the housing in which the sail is arranged in a folded manner in the non activated state.

It is emphasized that the sail 10 may also be stowed in other regions of the motor vehicle, for example in the soft trim of the pillars. The connecting points of the sail to the side structure or side trim are to be determined as a function of the geometry of the motor vehicle and the length of the motor vehicle.

FIG. 2 shows a side impact protection device which differs from the protection device illustrated in FIG. 1 by the fact that the sail is not of continuous design, but comprises a plurality of subsegments 10a, 10b, 10c which are connected to one another. In the unfolded state, the subsegment 10a extends between the A-pillar and the B-pillar, the segment 10b between the B-pillar and the C-pillar, and the segment 10c between the C-pillar and the D-pillar. The connection between the segment 10a and the segment 10b takes place via a band 33 which connects the adjacent subsegments in the lower region to one another. Alternatively, the connection between adjacent subsegments 10a, 10b, 10c can also take place over continuous sail material by means of a lower strip 34, in which case the sail material is recessed in the region 15 above the strip 34.

The traction device 30 extends as before along the lower region of the subsegments 10a, 10b, 10c and connects all three subsegments 10a, 10b, 10c to one another. It is thereby ensured that despite the formation of the sail 10 from individual subsegments, tightening of the entire sail takes place in the event of a collision.

Alternatively, the traction device 30 is divided into subsections connected by the sail material, the subsections merely connecting the subsegments 10a, 10b, 10c to one another and connecting outer subsegments 10a, 10c to the tensioning devices 41, 42. The focus is thus to be solely on the function of providing a continuous tightening of the lower region of the sail 10 over entire subregions. The formation of the sail from a plurality of interlinked sub-sail segments 10a, 10b, 10c has the advantage that a problem-free unfolding is also possible in the region of the B-pillar and C-pillar.

In the exemplary embodiment of FIG. 2, further traction device or tightening lines 31, 32 are provided, which means or lines extend in each case between the tensioning device 41, 42 and the lateral border 14, 15 of the unfolded sail 10 a, 10c. By means of this additional traction device, it is ensured that the sail is unfolded in a flash when the tensioning devices 41, 42 are triggered and an improved tensioning of the sail is made possible. Provision may be made for the pulling-out of the sail or of the traction device 30, 31, 32 to be made easier via slide-off ramps or other structural unfolding aids. The unfolding aids are formed on the bodywork or as part of the soft trim of the pillars or as part of the roof lining material.

In a further alternative, provision is made for the individual subsegments 10a, 10b, 10c to be triggered separately and tensioned by means of an intelligent sensor arrangement. Provision is made in this case to carry out the unfolding of the subsegments via traction device or tightening lines which are connected to tensioning devices and are preferably guided vertically in the pillars. In this case, the subsegments are tensioned between the individual pillars. Provision may also be made for the subsegments or tensioning devices to be triggered in a time-delayed manner. The effect achieved by this is that, for example in the case of a rollover, a time-delayed, active tensioning of the individual subsegments takes place, so that an extension of the tensioning time is achieved.

FIG. 3 shows an exemplary embodiment of the protection device according to the invention, in which the traction device 30 is connected at only one end to a tensioning device 41, in contrast, the other end is connected in a positionally fixed manner to the motor vehicle via a fastening point 21. However, the function of bracing the sail 10 can be implemented just as readily, since, after triggering of the tensioning device 41, the traction device 30 is subjected to a force in the direction of the tensioning device and, owing to its fixed connection to the motor vehicle, is tensioned at point 21 and thus brings about a bracing of the sail connected to the traction device.

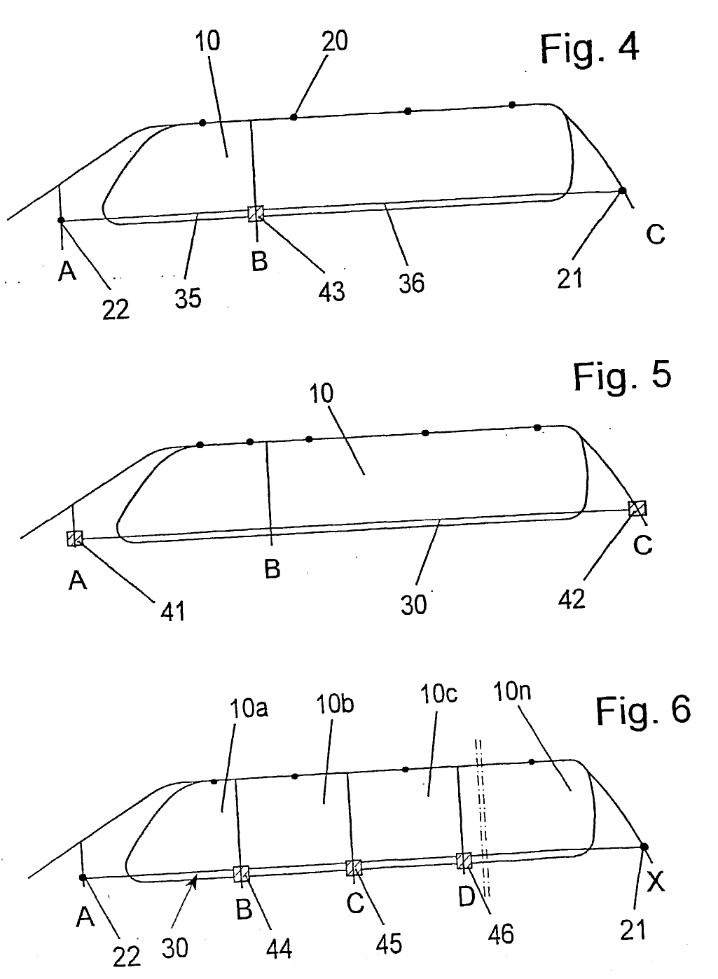

In the case of the embodiment of FIG. 4, the traction device 30 is divided into two subregions 35, 36, the outer ends of which are in each case connected to the motor vehicle bodywork in a positionally fixed manner at fastening points 22, 21 and the two other ends of which are connected to a tensioning device 43. The tensioning device 43 exerts a tensile force on at least one end of the traction device 35, 36, so that the traction device is tensioned as a whole between the two fastening points 22, 21. If appropriate, in the exemplary embodiment of FIG. 4 additional traction device are provided for pulling out and unfolding the sail in the event of a collision, said means likewise being connected to the tensioning device 43 or to further tensioning devices.

The exemplary embodiment of FIG. 5 corresponds essentially to the exemplary embodiment of FIG. 4, again a single-part, continuous sail 10, which extends between the A- and C-pillars, being provided.

The exemplary embodiment of FIG. 6 corresponds essentially to the exemplary embodiment of FIG. 4, a tensioning device 44, 45, 46 being arranged, however, on each of the motor vehicle pillars (B-pillar, C-pillar, D-pillar, etc.) arranged between the A-pillar and the rearmost pillar. The tensioning device 44, 45, 46 in each case interrupts the traction device 30 and is connected to both ends of the interrupted traction device. Each tensioning device 44, 45, 46 tensions at least one end of the interrupted traction device, so that overall a tightening and tensioning of the traction device 30 take place between the fastening points 22, 21, which are fixed on the bodywork, on the A-pillar and X-pillar.

Provision may also alternatively be made in this embodiment for the individual subsegments to be triggered and tensioned separately.

FIG. 10 shows a side impact protection device according to the invention, in which the protective element is designed as an airbag. The airbag can be of continuous design in a similar manner to FIG. 1, or can comprise a plurality of subsegments 50a, 50b, 50c as in FIG. 10. Each subsegment has a dedicated gas generator 51a, 51b, 51c for filling the subsegment 50a, 50b, 50c. There is no air exchange between the individual subsegments 50a, 50b, 50c. In FIG. 10, the two front subsegments 50a, 50b have a cutout, which separates them, in the region of the B-pillar. In contrast, the two rear subsegments 50b, 50c are directly adjacent to each other and are separated from each other only by a vertical seam. Furthermore, refinements corresponding to FIG. 2 may be provided.

The use of subsegments has the advantage that the narrow constructional space in the region of the pillars is kept free, since complex gas conducting systems can be omitted. Each airbag is filled separately.

The individual subsegments 50a, 50b, 50c of the airbag are connected at their lower regions by a traction device 30 which, as described previously, is actively tensioned by means of tensioning devices 41, 42, 43, 44 in the event of a collision and, as a result, ensures an effective bracing of the airbag along the entire, lower edge.

Unlike in the case of a sail as the protective element, the unfolding or inflation of the airbag takes place essentially automatically when filling with gas, so that when an airbag is used as tensioning element, the tensioning devices 41, 42, 43, 44 are used above all for an active bracing of the airbag. However, they may additionally also serve as an unfolding aid, in which case they pull the airbag, during the unfolding thereof, in the vertical direction into a desired end position. For this case, additional traction device or tightening lines which are guided approximately vertically on the respective pillar are preferably provided.

A triggering of two adjacent tensioning devices 41, 43, 44, 42 takes place, for example, as soon as the associated airbag segment 50a, 50b, 50c is filled with gas. For example, the tensioning devices 41, 43 are triggered when the associated airbag element 50ais filled by the gas generator 51 a or the gas generator 51a is triggered. A triggering of the tensioning devices may also take place in a time-delayed manner to the triggering of the airbag in order first of all to wait for the filling process before active bracing takes place.

The airbag 50a, 50b, 50c has chambers 52 which run essentially horizontally and are produced by connecting the front layer and the rear layer of the airbag fabric along connecting lines 53 running essentially horizontally. Alternatively, a pointwise connection of the front and rear layers of the airbag fabric may also take place. Since an active bracing of the airbag is ensured by the traction device 30 connected to the individual airbag segments 50a, 50b, 50c, the bracing between the individual motor vehicle pillars A, B, C, D takes place irrespective of the spatial arrangement of the chambers 52.

In order, when horizontal chambers are used, to ensure a rapid unfolding of the airbag, the tensioning devices 41, 42, 43, 44 preferably additionally serve as an unfolding aid. It is also possible to use additional tensioning devices as an unfolding aid.

It is emphasized that in the preceding exemplary embodiments, the tensioning devices are not activated by the filling of the airbag, but independently thereof. This has the advantage that a tightening takes place irrespective of the internal pressure of the airbag or of the airbag segments.

The invention is not restricted in its design to the above-described exemplary embodiments. The only essential feature for the invention is that an elongate traction device, which is fastened in the lower region of an unfolded protective element, is actively tensioned by means of at least one tensioning device in the event of a collision and therefore leads to an enduring and efficient bracing of the protective element in the final unfolded state.

The priority application DE 100 22 078.9 filed on May 3, 2000 is incorporated by reference herein in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A side impact protection device for protecting the head/thorax region of a motor vehicle occupant comprising:
an unfoldable protective element
a traction device located adjacent a lower edge of the unfolded protective element; the traction device being connected to the protective element and extending between two fixed points on the vehicle which are spaced apart in the longitudinal direction of the vehicle, and
a tensioning device connected to the vehicle for tensioning the traction device between the two fixed points after the protective element is unfolded; and
wherein the tensioning device exerts a tensile force on the traction device in the longitudinal direction of the unfolded protective element.

2. The protection device of claim 1, wherein the traction device comprises a cable.

3. The protection device of claim 2, wherein the cable passes through loops in the protective element.

4. The protection device of claim 2, wherein the cable is threaded into the protective element.

5. The protection device of claim 2, wherein the cable passes through a tuck in the protective element.

6. The protection device of claim 1, wherein the traction device is bonded to the protective element.

7. The protection device of claim 1, wherein the traction device is sewn into the protective element.

8. The protection device of claim 1, wherein the traction device comprises a band.

9. The protection device of claim 1, wherein the traction device includes separate sections that are connected together.

10. The protection device of claim 1, wherein the protective element is includes a single inflatable section.

11. The protection device of claim 1, wherein the protective element comprises a plurality of sections which are spread out in the longitudinal direction of the motor vehicle and are connected to one another by the traction device in lower regions of the sections.

12. The protection device of claim 1, wherein the traction device is connected to the motor vehicle by the tensioning device.

13. The protection device of claim 1, comprising two tensioning devices for tensioning the traction device, said tensioning devices each holding one end of the traction device.

14. The protection device of claim 1, wherein the tensioning device is located at one longitudinal end of unfolded protective element and holds one end of the traction device, the other end of the traction device being fixed to the vehicle adjacent the opposite longitudinal end of the airbag.

15. The protection device of claim 1, wherein the traction device is fixed to the vehicle at both of its ends, and the tensioning device is positioned between the two ends of the traction device.

16. The protection device of claim 1, wherein the traction device is fixed to the vehicle at both of its ends, and wherein the tensioning device includes a plurality of tensioning devices each device positioned on a separate motor vehicle pillar for tensioning the traction device, each of the plurality of tensioning devices dividing the traction device into sections and tensioning at least one end of one of the adjacent sections of the traction device.

17. The protection device of claim 1, wherein the tensioning device includes a restraining device for blocking a return movement of the traction device.

18. The protection device of claim 1, wherein the tensioning device is triggered by a central triggering device.

19. The protection device of claim 1, wherein the tensioning device is triggered by a sensor.

20. The protection device of claim 1, further comprising unfolding aids arranged on the motor vehicle structure.

21. The protection device of claim 1, wherein the protective element comprises an airbag.

22. The protection device of claim 21, wherein the airbag includes a plurality of air chambers.

23. The protection device of claim 21, wherein the airbag comprises a plurality of chambers a plurality of gas generators so that each chamber can be filled by a dedicated gas generator.

24. The protection device of claim 17, wherein the tensioning device is configured to serve as an unfolding aid for the airbag.

25. The protection device of claim 1, wherein the protective element comprises a non-expandable sheet of material.

26. The protection device of claim 25, wherein the tensioning device causes the unfolding of the sheet.

27. The protection device of claim 26, further comprising an additional traction device connected to the sheet that interacts with a tensioning device to unfold the sheet in the event of a crash.
